(19) United States
(12) Patent Application Publication
(10) Pub. No.: US 2026/0138193 A1
(43) Pub. Date: May 21, 2026

(54) Boring Tool

(71) Applicants: Chad Touchet, Pinehurst, TX (US); Londen Touchet, Pinehurst, TX (US)

(72) Inventors: Chad Touchet, Pinehurst, TX (US); Londen Touchet, Pinehurst, TX (US)

(21) Appl. No.: 18/950,248

(22) Filed: Nov. 18, 2024

(51) Int. Cl. B23B 29/034

(52) U.S. Cl. CPC B23B 29/034; B23B 2229/00

(57) ABSTRACT

The present invention discloses a boring tool apparatus that comprises a head, stem and tool connector. The tool connector may be connected to the stem on one end and to a hand held power tool on the other end. Alternatively, the apparatus may comprise a stem tail to attach the tool connector to a hand held power tool. The tool connector may be placed in the stem tail such that the stem end of the tool connector is held securely in the stem tail by means of a cap and the power tool end of the tool connector is exposed outside the stem tail to connect to a hand held power tool. The apparatus may also comprise attachment for wire, sleeve, pipe, or cable to ride with it as a bore is created. Also disclosed herein is the method of boring a hole using the apparatus of the present invention.

### CROSS REFERENCE TO RELATED APPLICATIONS

Non-Applicable.

### FIELD

The present disclosure generally relates to an apparatus used to bore or tunnel through soil. Specifically, the present invention provides a boring tool apparatus comprising a head, stem, and tool connector. On one end of the head is the boring end that is tapered in at least one dimension and opposite to the boring end is a connecting end. The stem has a head end that is opposite to the tool end. The head end of the stem is connected to the connecting end of the head. The tool connector has a stem end opposite to a power tool end. The stem end of the tool connector is connected to the tool end of the stem and the power tool end of the tool connector is connected to a hand-held power tool end. Additionally, this apparatus further comprises a stem tail to attach the tool connector to the apparatus. The apparatus also comprises a cap that can hold the tool connector securely to the apparatus when the tool connector is connected to the apparatus. The apparatus is also designed to enable insertion or attachment of a sleeve, pipe, wire, tubing, or cable to ride with it as a bore is created, had at least one attachment point on the outside to attach a wire or string while boring, or a combination thereof.

### BACKGROUND

Nowadays, laying pipes, wires, cables, ropes, tubes, or the like has increased in demand, whether to lay fiber optic cable, move above wiring below ground, modifying plumbing, or install irrigation.

Traditionally, when placing pipes, wires, cables, ropes, tubes, or running any object through the ground, the grass and topsoil must be removed, and a trench must be dug. This becomes tedious when the surface of the ground is layered with concrete, asphalt, or other hard surfaces that must be broken down, removed, and then reapplied after running the desired material through the ground. This method presents an issue because of the extra work, time, and cost required in digging, removing hard surfaces, and repairing the surface to the initial condition.

Hence, there is a need for an apparatus that makes boring a hole or tunnel efficient and economical. The present invention meets these needs.

### SUMMARY OF THE INVENTION

A boring tool apparatus to bore or tunnel through soil to allow insertion or placement of long hollow cylindrical conduits or wire(s) including but not limited to a pipe, sleeve, wire, cable, rope, or tube in the hole and tunnel. The boring apparatus comprises a head, a stem, and a tool connector. The stem connects the head and the tool connector and is provided by the operator.

The head has a boring end opposite to a connecting end, where the boring end of the head is tapered in one dimension away from the connecting end. The head may be tapered enough to allow the long hollow cylindrical conduits or wire(s) to ride with the head during the boring operation. The head may also have a fixture or attachment for a wire or string that the operator can pull during the boring operation. Additionally, the head may or may not have at least one fluid pathway to allow fluid to pass through the head while boring. The head may comprise a pipe shoulder to allow a pipe to be attached to the head.

The stem of the apparatus has a head end that is opposite to a tool end. The head end of the stem is connected to the connecting end of the head. The tool end of the stem is connected to a tool connector. The tool connector has a stem end opposite to a power tool end. The stem end is connected to the tool end of the stem while the power tool end is connected to the power tool. An example of the tool connector is a reciprocating flat bar described herein, which has one end that is connected to the tool end of the stem and the other end which is inserted or placed inside a power tool. The tool connector is either directly connected to the tool end of the stem or is connected to the tool end by means of a stem tail. Additionally, the apparatus also comprises a cap that can hold the tool connector (for example, the reciprocating flat bar) securely to the apparatus when the tool connector is connected to a hand-held power tool. The tool connector is securely attached to or held by the cap that has at least two screws to hold it in place. The cap may be fixed or detachable.

Also described herein is the method of boring a hole using the boring tool apparatus described herein. This method comprises digging a trench adjacent to start location of a desired bore hole, attaching the above-mentioned apparatus to a hand-held power tool and then energizing the power tool and creating the desired bore hole. The method may include providing fluid source to the stem fluid pathway of the above-mentioned apparatus and forcing the fluid through the stem and head fluid pathways to help in boring. Additionally, a wire or string may be attached to the head of the above-mentioned apparatus during boring operation and then detaching the wire or string when it has reached the desired destination point. Another alternative will be to attach or insert a pipe in the narrow head of the apparatus so that it can ride along with the head as the boring operation is in progress.

In a preferred embodiment of the present invention is a boring tool apparatus for a hand-held power tool. This apparatus comprises a head having a boring end opposite a connecting end, wherein the boring end tapers in at least one dimension from the connecting end; a stem having a head end opposite a tool end, wherein the head end is connected to the connecting end; a tool connector having a stem end opposite a power tool end, wherein the stem end is connected to the tool end, and further wherein the power tool end is adapted to attach to a hand-held power tool.

In one embodiment of the preferred boring tool apparatus, the boring end of the head tapers in the direction away from the connecting end of the head such that the tapered end may or may not allow a sleeve or pipe to ride with the head as a bore is being created. In another embodiment of the preferred boring tool apparatus, the head further comprises no fluid pathway or at least one head fluid pathway to allow fluid to pass through the head and aid in boring. In yet another embodiment of the preferred boring tool apparatus, the head comprises no attachment point or at least one attachment point for a wire or string to be attached thereto. In another embodiment of the preferred boring tool apparatus, the head further comprises a pipe shoulder allowing a pipe to be attached to the head. In still yet another embodiment of the preferred boring tool apparatus, the connecting end of the head is threaded or not threaded.

In another embodiment of the preferred boring tool apparatus, the connecting end of the head comprises a squared off section to help in removing the head from the stem. In yet another embodiment of the preferred boring tool apparatus, the stem comprises no fluid pathway or at least one fluid pathway to pass through it and aid in boring. In further yet another embodiment of the preferred boring tool apparatus, the stem comprises a single stem section or a plurality of stem sections, wherein the plurality of stem sections is affixed or connected to each other to form a single stem section.

In another embodiment of the preferred boring tool apparatus, the stem comprises a stem tail for attachment to tool connector. In yet another embodiment of the preferred boring tool apparatus, the apparatus further comprises a cap to connect to attach to a hand-held power tool. In yet another embodiment of the preferred boring tool apparatus, wherein the cap holds the tool connector securely. In further yet another embodiment, the cap, the tool connector, or both are replaceable.

In another embodiment of the preferred boring tool apparatus, the hand held power tool is a reciprocating power tool. Example of the hand held power tool includes but is not limited to a reciprocating saw. In yet another embodiment, the head, the tool connector, or both the head and tool connector are replaceable.

In another embodiment of the invention is a preferred method of boring a hole. This method comprises digging a trench adjacent to a start location of a desired bore hole; attaching the preferred apparatus described above to a hand-held power tool; placing the apparatus and the hand-held power tool within the trench; energizing the hand-held power tool; and creating the desired bore hole. In one embodiment of the preferred method, the method further comprises the steps of providing a fluid source in fluid communication with the stem fluid pathway; and forcing the fluid through the stem fluid pathway and the head fluid pathway to aid in boring. In another embodiment of the preferred method, the method further comprises the steps of attaching a wire or a string to the wire attachment point; digging a second trench at a desired terminus of the desired bore hole; and detaching the wire or the string from the wire attachment point.

### BRIEF DESCRIPTION OF THE DRAWINGS

So that the matter in which the present invention can be better understood, certain illustrations are appended hereto. It is to be noted, however, that the drawings illustrate only selected embodiments of the inventions and are therefore not to be considered limiting of scope, for the inventions can admit to other equally effective embodiments and applications.

Moreover, advantages and other aspects of the invention will be readily appreciated by those persons having skill in the art and may be better understood with further reference to the accompanying drawings in which like reference characters designate like or similar elements throughout the several figures of the drawings. The detailed description will be better understood in conjunction with the accompanying drawings as follows:

FIG. 1 illustrates the boring tool apparatus attached to a power tool.

FIG. 2 illustrates the head of the boring tool apparatus.

FIG. 3A illustrates the cap side up view of the stem tail. FIG. 3B illustrates the side view of the stem tail. FIG. 3C illustrates the view of the stem tail with the cap underneath. FIG. 3D illustrates the cap with holes or cavity for screws.

FIGS. 4A and 4B illustrate the tool connector (i.e. a reciprocating flat bar). FIG. 4A depicts a single reciprocating flat bar while FIG. 4B depicts multiple reciprocating flat bars.

The embodiments of the present disclosure are detailed below with reference to the listed Figures. However, it should be understood that the above-described figures are not intended to be limited to only the invention illustrated and to the particular embodiments disclosed, but on the contrary, it is intended to disclose all modifications, alternatives, and equivalents falling within the spirit and scope of the invention as defined within the claim's broadest reasonable interpretation consistent with the specification.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about” means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

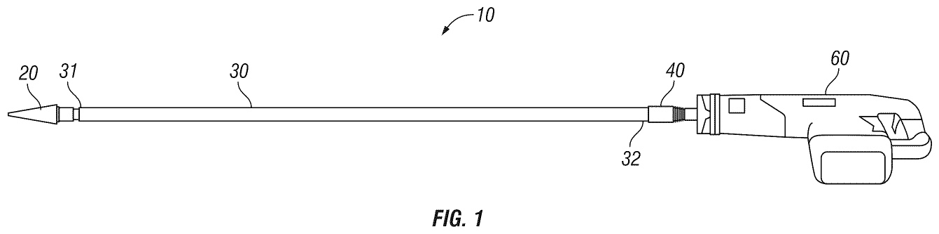

As detailed in FIG. 1, the present invention that is a boring tool apparatus 10 attached to a power tool 60. The boring tool apparatus 10 comprises a head 20, a stem 30, and a tool connector 50 (not shown). FIG. 1 shows a stem tail 40 that is attached to power tool 60 on one end and to stem 30 on the other end. One end of stem 30 is connected to one end of head 20 while the opposite end of stem 30 is connected to a tool connector 50 (not shown) or stem tail 40. For example, head end 31 of stem 30 is connected to head 20 while tool end 32 of stem 30 is connected to tool connector 50 or stem tail 40. The stem 30 may comprise a single stem section or a plurality of stem sections wherein the plurality of stem sections is connected or affixed to each other to form one single stem section. The stem 30 is a long, hollow cylinder or conduit that is made of materials including but not limited to metal, plastics, glass, additive material or similar such material or a combination thereof and is capable of carrying or transporting liquids or gases. Head 20 is made of materials including but not limited to metal, plastics, additive material or similar such material that are strong and can withstand the pressure or tension exerted during boring operation or a combination thereof.

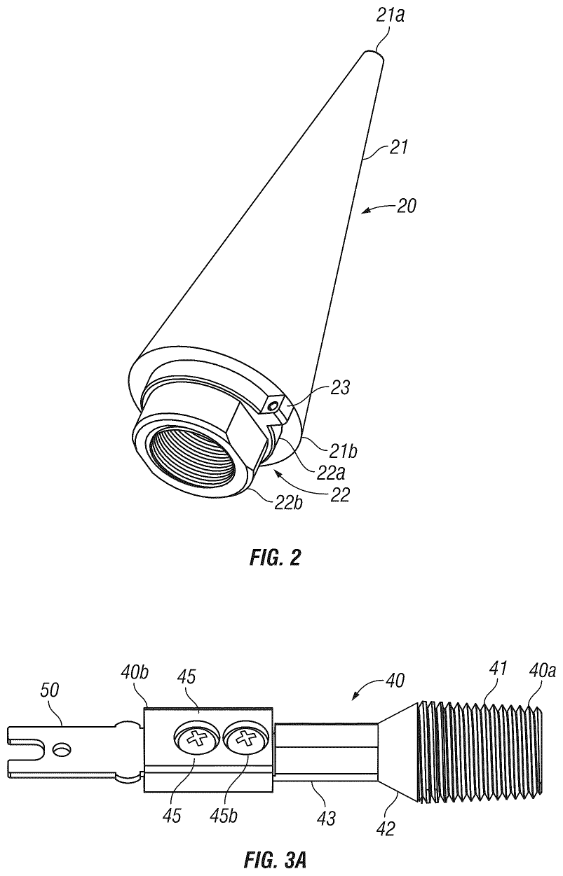

As detailed in FIG. 2, head 20 comprises a boring end 21 and a connecting end 22, wherein the boring end 21 and connecting end 22 are coaxially placed. The boring end 21 tapers away in one dimension from the connecting end 22 and comprises a narrow end 21a and a round base end 21b. The connecting end 22 comprises a flat, square or hexagonal piece of metal or other material including but not limited to plastic, poly-vinyl chloride, polyethylene, additive material or combination thereof, and may or may not be threaded. The connecting end 22 comprises head end 22a and stem end 22b. The head end 22a is connected to the round base end 21b while stem end 22b is connected to head end of stem 30. The stem end 22b may be squared off to aid in removing the head 20 from stem 30. Additionally, head 20 may have an attachment point 23 to attach a wire or string or cable to head 20. Attachment point 23 can be placed anywhere on apparatus 20, a preferable location for attachment 23 is in the junction between round base end 21b and head end 22a as illustrated in FIG. 2. An example of attachment point 23 includes but is not limited to a circular ring with at least one loop or hole on the side to insert a wire or string through it.

Further head 20 may (not shown in FIG. 2) or may not include at least one hole, orifice or outlet at boring end 21a that would allow fluid under pressure to pass through head 20. The hole, orifice or outlet may be large enough to allow the fluid to flow easily through it and assist in increasing the efficiency of the boring or tunneling process.

Pushing long hollow cylinder or tube (e.g. pipe) or a protective or connecting tube fitting over another tube or cylinder (e.g. sleeve) after boring has been completed has a disadvantage because it allows rocks, soil, debris, etc. to enter this hollow cylinder or tube, or protective or connecting tube fitting. To address this, head 20 may include an area tapered enough to allow the hollow cylinder or tube or the protective or connecting tube fitting of a certain size to ride with head 20 as the boring operation is in process. This will allow the operator to include the hollow cylinder or tube or the protective or connecting tube fitting to ride along as the bore is being created and avoids the operator from having to push the hollow cylinder or tube or the protective or connecting tube fitting at a later time. The hollow cylinder or tube or the protective or connecting tube fitting may be made of materials including but not limited to metal, plastic, additive material or a combination thereof.

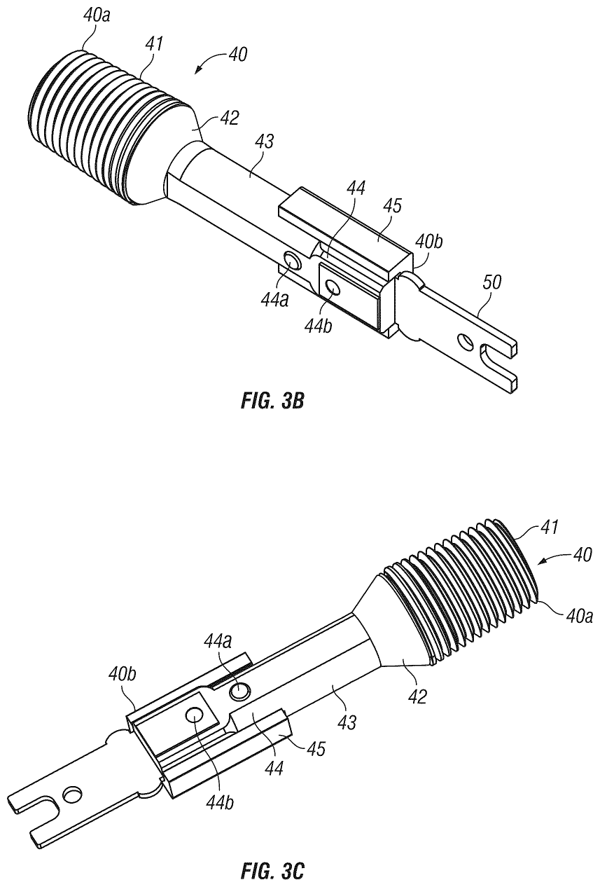

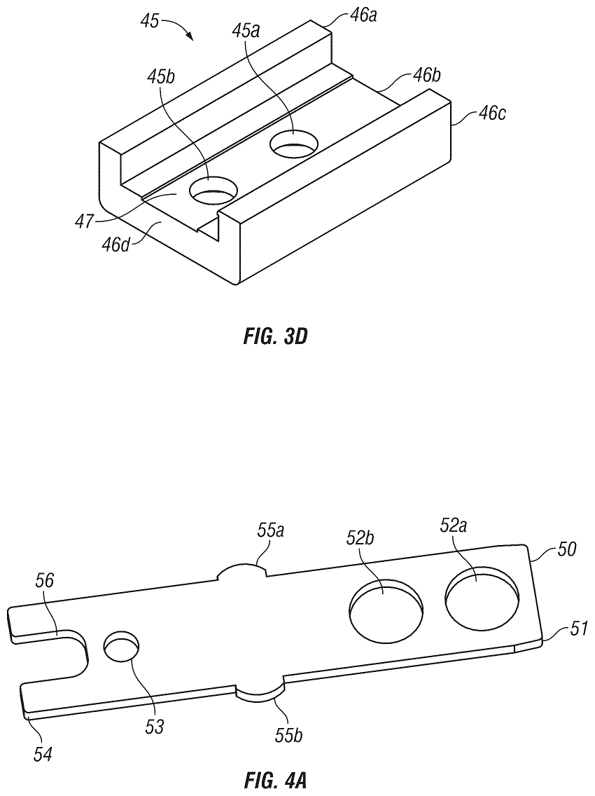

The boring tool apparatus of the present invention further comprises a stem tail 40 for attachment to the tool connector (or a reciprocating flat bar) 50 as illustrated in FIGS. 3A, 3B, and 3C. Additionally, the boring tool apparatus may also comprise cap 45 to attach to hand-held power tool. The stem tail 40 comprises a truncated barrel 41 on stem end 40a and a cylindrical shaft 43 that extends away from truncated barrel 41 towards tool connector end 40b and is connected to truncated barrel 41 via short neck 42. The tool connector end 40b is leveled. The length of neck 42 may vary depending on the preference of the user. The truncated barrel 41 may or may not be threaded. Alternatively, shaft 43 may be directly connected to truncated barrel 41 in the absence of neck 42 or shaft 43 may be connected directly to stem 30. The length and width of shaft 43 can vary. Both sides of shaft 43 are flat. One side of shaft 43 has a L-shaped loading area 44 to place cap 45 and tool connector or reciprocating flat bar 50. The surface of the loading area 44 has at least two holes or cavities 44a and 44b that align with holes or cavities 45a and 45b of cap 45. The length of loading area 44 is long enough to accommodate cap 45 and part of reciprocating flat bar 50.

FIG. 3D illustrates cap 45 of the present invention. Cap 45 consists of an enclosed surface 47 in connection with two (2) side surfaces 46a and 46c that are opposite to each other, themselves extending upwards and away from the enclosed surface 47 and positioned substantially orthogonally (in a perpendicular plane to the bottom surface plane). Substantially orthogonally, as it pertains to the present invention and positioning, is defined as being largely perpendicular and within ten degrees of a right angle created at the juncture between enclosed surface 47 in connection with two (2) side surfaces. The other two (2) opposing side surfaces 46b and 46d do not extend upwards and away from enclosed surface 47. The surface opposite to or facing enclosed surface 47 is not enclosed. The length and width of cap 45 will depend on the length and width of shaft 43 as cap 45 has to fit in loading area 44 of shaft 43. In FIGS. 3A, 3B, 3C, and 3D, side surfaces 46 a and 46 c are longer in length than side surfaces 46 b and 46d. Enclosed surface 47 also has at least two holes or cavities 45a and 45b that align with holes or cavities 44a and 44b (shown in FIGS. 3B AND 3C) when cap 45 is placed in loading area 44. Cap 45 not only aids in holding tool connector or reciprocating flat bar 50 in place but also makes it easy to replace tool connector or reciprocating flat bar 50, if needed.

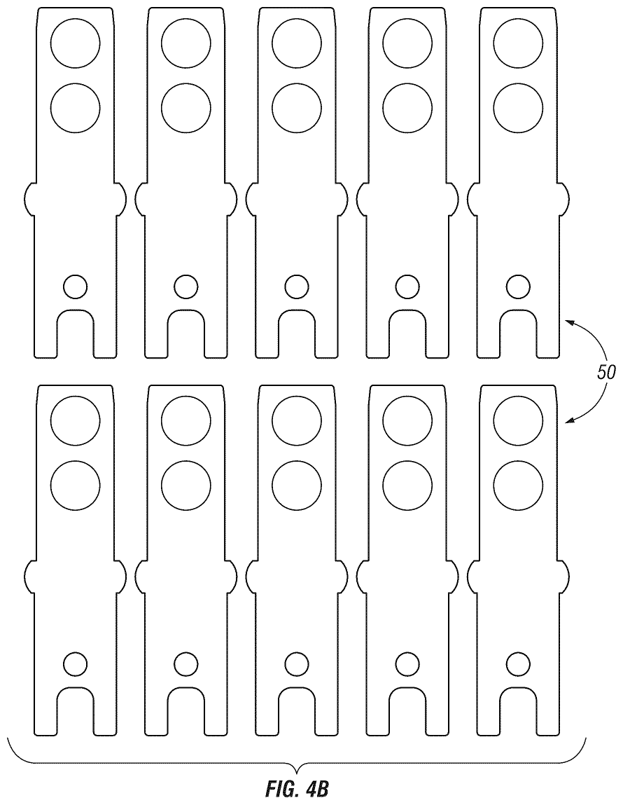

The tool connector (or reciprocating flat bar) 50 of the present invention is a flat, rectangular piece of metal with a stem end 51 opposite to a power tool end 54 as illustrated in FIG. 4A. Close to stem end 51 are at least two holes or cavities 52a and 52b that are large enough to insert securing mechanism including but not limited to screws. Located further down from holes 52a and 52b and on either side of tool connector 50 are protrusions 55a and 55b. At the power tool end 54 is a notch 56 that fits in the socket of the hand held power tool 60. Additionally, tool connector 50 may also have a hole 53 above notch 56.

The stem end 51 of tool connector 50 can be connected to the tool end 32 of stem 30 (the parts of stem 30 are shown in FIG. 1) directly or placed in loading area 44 of stem tail 40 (shown in FIGS. 3A, 3B, 3C). When placed in loading area 44, tool connector or reciprocating flat bar 50 is held in place by placing cap 45 on it and securing it by securing mechanism that include but are not limited to screws. Protrusions 55a and 55b enable holding tool connector 50 in such a way that stem end 51 is inserted in tool end 32 of stem 30 or in loading area 44 of stem tail 40, leaving the power tool end 54 exposed outside stem 30 or stem tail 40 to be inserted in the socket of hand held power tool 60.

FIG. 4B illustrates multiple tool connector 50. It is understood that tool connector 50 may be modified or its design altered to fit the socket of any power tool.

Also, provided herein is the method of boring a hole using the apparatus of the present invention. Briefly, a trench is dug adjacent to a start location of a desired bore hole. The above-mentioned apparatus is assembled and attached to a hand held power tool. For instance, the connecting end of head is attached head end of stem and stem end of tool connector is attached directly to tool end of stem or placed in stem tail and secured by cap. The notch at the power tool end of tool connector is inserted into the socket of the hand held power tool. The apparatus and the hand-held power tool are placed within the trench and the hand held power tool energized, and a bore hole is thus created.

Additionally, the method may also comprise attaching a fluid source in fluid communication with stem fluid pathway and forcing fluid through the stem fluid pathway and head fluid pathway to assist in boring a hole. The method may also comprise attaching a wire or string to the wire attachment point, digging a second trench at a desired terminus of the desired bore hole and detaching the wire or the string from the wire attachment point. Further, the method may also comprise attaching a pipe to the pipe shoulder, digging a second trench at a desired terminus of the desired bore hole and detaching the pipe from the pipe shoulder.

While the present disclosure emphasizes the embodiments, it should be understood that within the scope of the appended claims, the invention might be practiced other than as specifically described herein.

What is claimed is:

1. A boring tool apparatus for a hand-held power tool, comprising:
a. a head having a boring end opposite a connecting end, wherein the boring end tapers in at least one dimension from the connecting end;
b. a stem having a head end opposite a tool end, wherein the head end is connected to the connecting end;
c. a tool connector having a stem end opposite a power tool end, wherein the stem end is connected to the tool end, and further wherein the power tool end is adapted to attach to a hand-held power tool.

2. The apparatus of claim 1, wherein the boring end of the head tapers in the direction away from the connecting end of the head such that the tapered end may or may not allow a sleeve or a pipe to ride with the head as a bore is being created.

3. The apparatus of claim 1, wherein the head further comprises no fluid pathway or at least one head fluid pathway to allow fluid to pass through the head and aid in boring.

4. The apparatus of claim 1, wherein the head further comprises no attachment point or at least one attachment point for a wire or string to be attached thereto.

5. The apparatus of claim 1, wherein the head further comprises a pipe shoulder allowing a pipe to be attached to the head.

6. The apparatus of claim 1, wherein the connecting end of the head is threaded or not threaded.

7. The apparatus of claim 1, wherein the connecting end of the head comprises a squared off section to help in removing the head from the stem.

8. The apparatus of claim 1, wherein the stem comprises no fluid pathway or at least one fluid pathway to pass through it and aid in boring.

9. The apparatus of claim 1, wherein the stem comprises a single stem section or a plurality of stem sections wherein the plurality of stem sections is affixed or connected to each other to form a single stem section.

10. The apparatus of claim 1, wherein the stem comprises a stem tail for attachment to tool connector.

11. The apparatus of claim 1, further comprising a cap to attach the hand-held power tool.

12. The apparatus of claim 11, wherein the cap holds the tool connector securely.

13. The apparatus of claim 12, wherein the cap, the tool connector or both are replaceable.

14. The apparatus of claim 1, wherein the hand-held power tool is a reciprocating power tool.

15. The apparatus of claim 1, wherein the hand-held power tool is a reciprocating saw.

16. The apparatus of claim 1, wherein the head, the tool connector, or both the head and tool connector are replaceable.

17. A method of boring a hole comprising:
a. digging a trench adjacent to a start location of a desired bore hole;
b. attaching the apparatus of claim 1 to a hand-held power tool;
c. placing the apparatus of claim 1 and the hand-held power tool within the trench;
d. energizing the hand-held power tool;
e. creating the desired bore hole.

18. The method of claim 17, further comprising the steps of:
a. providing a fluid source in fluid communication with the stem fluid pathway;
b. forcing the fluid through the stem fluid pathway and the head fluid pathway to aid in boring.

19. The method of claim 17, further comprising the steps of:
a. attaching a wire or a string to the wire attachment point;
b. digging a second trench at a desired terminus of the desired bore hole;
c. detaching the wire or the string from the wire attachment point.

20. The method of claim 17, further comprising the steps of:
a. attaching a pipe to the pipe shoulder;
b. digging a second trench at a desired terminus of the desired bore hole;
c. detaching the pipe from the pipe shoulder.
